(19) United States
(12) Patent Application Publication
(10) Pub. No.: US 2018/0114186 A1
(43) Pub. Date: Apr. 26, 2018

(54) SYSTEMS AND METHODS FOR FACILITATING PICK UP OF PRODUCTS ORDERED FROM A RETAILER BY A CUSTOMER FROM OTHER CUSTOMERS OF THE RETAILER

(71) Applicant: Wal-Mart Stores, Inc., Bentonville, AR (US)

(72) Inventors: Tim W. Webb, Rogers, AR (US); Donald R. High, Noel, MO (US); Todd D. Mattingly, Bentonville, AR (US)

(21) Appl. No.: 15/730,124

(22) Filed: Oct. 11, 2017

Related U.S. Application Data
(60) Provisional application No. 62/410,983, filed on Oct. 21, 2016.

(51) Int. Cl. G06Q 10/08; G06Q 50/28

(52) U.S. Cl. CPC G06Q 10/0836; G06Q 50/28; G06Q 10/0833; G06Q 10/087

(57) ABSTRACT

In some embodiments, methods and systems are provided that permit a customer to purchase products from a retailer and elect an option for a friend or family member of the customer to pick up the ordered products from the retail facility of the retailer associated with the geographic location of the customer. If the friend or family member of the customer agrees to pick up the products for the customer, and if the customer agrees to have the selected friend or family member of the customer pick up the products for the customer, the friend or family member is allowed to pick up the products at the retail facility associated with the geographic location of the customer. The customer is then allowed to either pick up the products from such a friend or family member or the friend or family member may deliver the products to the customer.

### CROSS-REFERENCE TO RELATED APPLICATION

This application claims the benefit of U.S. Provisional Application No. 62/410,983, filed Oct. 21, 2016, which is incorporated herein by reference in its entirety.

### TECHNICAL FIELD

This invention relates generally to facilitating pick up of products ordered by consumers and, in particular, to facilitating pick up of products that were purchased from a retailer by a consumer from customers of the retailer.

### BACKGROUND

Consumers often purchase products from retailers over the internet. Generally, the products purchased by a consumer are delivered to an address provided by the consumer. Some consumers elect to pick up the products they order from a brick-and-mortar store of the retailer. Often, picking up ordered products from the brick-and-mortar store of the retailer is not convenient for the consumers, and requires the consumers to drive out of the way of their normal work-home commute. As such, picking up ordered products at the brick-and-mortar store of the retailer may be often undesirable for consumers because it is time consuming and/or otherwise inconvenient.

### BRIEF DESCRIPTION OF THE DRAWINGS

Disclosed herein are embodiments of systems, apparatuses, methods, and systems pertaining to facilitating pick up of products that were purchased from a retailer by a consumer from customers of the retailer. This description includes drawings, wherein:

FIG. 1 is a diagram of a system for facilitating pick up of products that were purchased from a retailer by a consumer from other customers of the retailer in accordance with some embodiments;

FIG. 2 is a functional diagram of an exemplary computing device usable with the system of FIG. 1 in accordance with some embodiments; and

FIG. 3 is a flow chart diagram of a process of facilitating pick up of products that were purchased from a retailer by a consumer from customers of the retailer in accordance with some embodiments.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, pursuant to various embodiments, systems and methods are provided for enabling a customer to purchase one or more products from a retailer and elect an option to pick up the products ordered by the consumer not from a retail facility of the retailer, but from a location (e.g., residence) provided by a customer of the retailer located in geographic proximity to a location of the consumer who purchased the products. In other words, the consumer who orders a product from a retailer is allowed to conveniently pick up the ordered product from a customer of the retailer who makes his or her residence, business, or storage facility available as a pick up location for consumers who order products from the retailer.

According to some embodiments, a system of facilitating consumer pick up of products purchased from a retailer includes an order processing server of the retailer configured to receive an order request for a product from an electronic device of a consumer and a computing device of the retailer in communication with the order processing server and including a processor-based control circuit. The computing device of the retailer is configured to access an electronic database of the retailer storing a plurality of product pick up locations provided by customers of the retailer. The control circuit of the computing device of the retailer is configured to select, from the plurality of product pick up locations stored in the electronic database, a first product pick up location provided by a first customer of the retailer. The order processing server is configured to process the order request for the product to complete a purchase of the product by the consumer in response to receiving, from the electronic device of the consumer, payment by the consumer for the product and for an additional cost of picking up the product from the first product pick up location provided by the first customer of the retailer.

In some embodiments, a method of facilitating consumer pick up of products purchased from a retailer includes: receiving, at an order processing server of the retailer, an order request for a product from an electronic device of a consumer; accessing, via a computing device of the retailer including a processor-based control circuit, an electronic database of the retailer storing a plurality of product pick up locations provided by customers of the retailer; selecting, from the plurality of product pick up locations stored in the electronic database and via the computing device of the retailer, a first product pick up location provided by a first customer of the retailer; and processing the order request for the product to complete a purchase of the product by the consumer in response to receiving, via the computing device of the retailer and from the electronic device of the consumer, payment by the consumer for the product and for an additional cost of picking up the product from the first product pick up location provided by the first customer of the retailer.

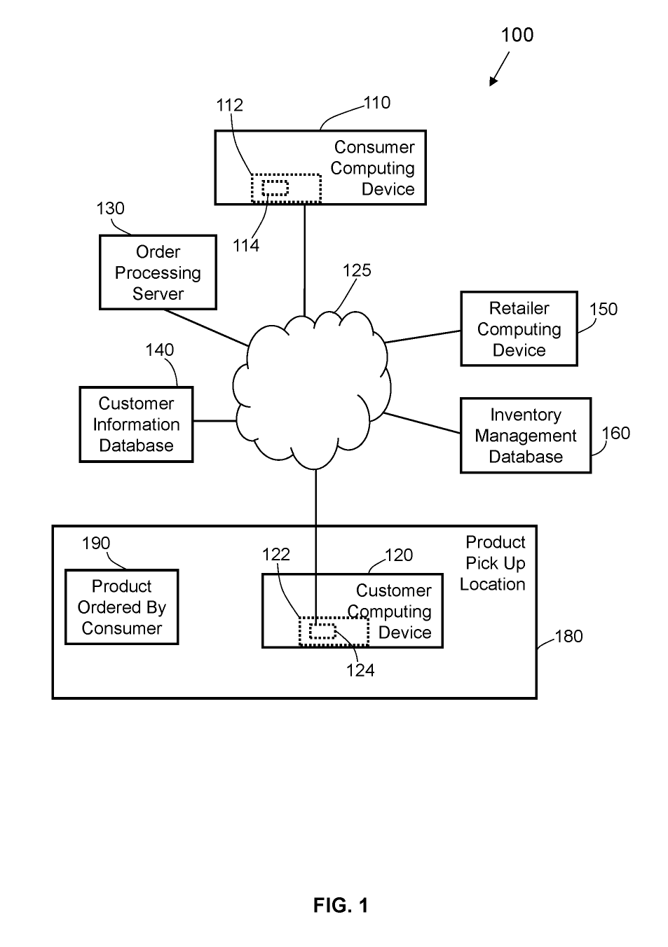

FIG. 1 shows an embodiment of a system 100 for facilitating pick up of products 190 that were purchased from a retailer by a consumer from another customer of the retailer. The retailer may be any entity operating as a brick-and-mortar physical location and/or a website accessible, for example, via the internet or another network, by way of which products 190 may be ordered by a consumer. A consumer may be an individual or business entity. Exemplary products 190 that may be ordered by the consumer from the retailer and picked up from a product pick up location 180 provided by a customer of the retailer via the system 100 may include, but are not limited to, general-purpose consumer goods, as well as consumable products, such as medications, food items, and dietary supplements.

The exemplary system 100 depicted in FIG. 1 includes an order processing server 130 of the retailer configured to process a purchase order by the consumer for one or more products 190 offered for sale by the retailer. The order processing server 130 may be implemented as one server at one location, or as multiple interconnected servers stored at multiple locations operated by or for the retailer. As described in more detail below, the order processing server 130 may communicate with one or more electronic devices of system 100 via a network 125. The network 125 may be a wide-area network (WAN), a local area network (LAN), a personal area network (PAN), a wireless local area network (WLAN), or any other internet or intranet wired or wireless network, or combinations of such networks. Generally, communication between variously electronic devices of system 100 may take place over hard-wired, cellular, Wi-Fi or Bluetooth networked components or the like. In some embodiments, one or more electronic devices of system 100 may include cloud-based features, such as cloud-based memory storage.

In the embodiment of FIG. 1, the order processing server 130 is coupled to a customer information database 140. In some embodiments, the customer information database 140 may be configured to store information associated with consumers who order products 190 from the retailer and/or information associated with customers of the retailer who opted to provide product pick up locations 180 for the consumers who order products 190 from the retailer. Such electronic information may include but is not limited to the consumers' and/or customers' personal information (e.g., name, address, etc.), payment options, product order history, pending order status, product order options, product delivery and/or product pick-up options.

The customer information database 140 may be stored, for example, on non-volatile storage media (e.g., a hard drive, flash drive, or removable optical disk) internal or external to the order processing server 130, or internal or external to computing devices separate and distinct from the order processing server 130. It will be appreciated that the customer information database 140 may likewise be cloud-based. While the customer information database 140 and the order processing server 130 have been shown in FIG. 1 as separate devices, it will be appreciated that in some embodiments, the customer information database 140 and the order processing server 130 may be incorporated into one computing device. Similarly, while the order processing server 130, customer information database 140, retailer computing device 150, and inventory management database 160 are shown in FIG. 1 as separate devices, it will be appreciated that any two or more of these devices may be incorporated into one computing device in some embodiments.

In some embodiments, when a consumer initially sets up an online account with the retailer, the system 100 (i.e., order processing server 130 or another server on the system 100 dedicated to new consumer sign-up) is configured to permit the consumer generate a consumer profile including personal information of the consumer (e.g., name, address, phone number, and the like), payment methods (e.g., credit card information, bank account information, or the like), and product pick up settings of the consumer (e.g., a specific location or a list of locations where consumer would like to pick up the ordered products 190 or a geographic area within which the consumer is willing to pick up the ordered products 190 at a product pick up location 180). It will be appreciated that the consumer may select new options and/or update previously selected options at any time after setting up the account with the retailer. In some embodiments, the personal information of the consumer and any product pick up-related options selected by the consumer are stored in the customer information database 140 and/or inventory management database 160 for subsequent access/retrieval by the order processing server 130 and/or by a retailer computing device 150 in response to a login request or in response to a product order request by the consumer.

In some embodiments, when a customer of the retailer wants to opt in as an authorized product pick up location 180 where a consumer who ordered products 190 from the retailer can pick up the products 190, the customer can use a customer computing device 120 to set up an online account with the retailer and generate a customer profile including personal information of the consumer (e.g., name, address, phone number, and the like), methods of receiving payment (e.g., credit card information, bank account information, or the like), product pick up hours offered, as well as any information relevant to physical access of the product pick up location 180 by a consumer coming to pick up a product 190 at the product pick up location 180. It will be appreciated that the customer who opts in as an authorized product pick up location 180 may select new options and/or update previously selected options at any time after setting up the account with the retailer. In some embodiments, the personal information of the customer and any product pick up-related options and/or requirements selected by the customer are stored in the customer information database 140 and/or inventory management database 160 for subsequent retrieval by the order processing server 130 and/or by a retailer computing device 150 (e.g., when fulfilling an order placed by a consumer).

A customer who opted in as an authorized product pick up location 180 where a consumer who ordered products 190 from the retailer can pick up the products 190 may access the order processing server 130 of the retailer via a customer computing device 120, which may be a stationary, portable, and/or hand-held electronic device, for example, a desktop computer, a laptop computer, a tablet, a mobile phone, or any other electronic, processor-based device that may be configured for data entry and communication over the network 125 with the order processing server 130, as well as one or more of the customer information database 140, retailer computing device 150, inventory management database 160, and consumer computing device 110. In some embodiments, the customer may access the order processing server 130 of the retailer via a graphical interface 122 displayed to the consumer on the customer computing device 120. The graphical interface 122 may include one or more graphical input fields 124 in the form of menu options and/or sub-interfaces that permit the customer to set up various product pick up and/or product restocking options for the products 190 stocked at the product pick up location 180 provided by the customer. In one approach, the customer may utilize the graphical interface 122 of the customer computing device 120 to request a list of specific products 190 to be restocked, to set up periodic restocking of certain products 190 stored at the product pick up location 180, or to set up a bulk delivery of a certain product 190 to the product pick up location so that this product 190, when ordered by a consumer from the retailer, would be available for pick up to the consumer at the product pick up location 180 within a short period of time after placing the order request.

In some embodiments, the graphical interface 122 is a retailer-associated mobile application (app) installed on the customer computing device 120 and configured to display various menu options, notifications, and/or alerts for the consumer. The electronic alerts may be transmitted to the customer computing device 120 from the retailer computing device 150 and/or order processing server 130 and displayed to the customer via the graphical interface 122 of the customer computing device 120, requiring the customer to respond to the alerts by selecting appropriate input fields 124 in the graphical interface 122.

A consumer wishing to submit an order request for one or more products 190 to the retailer may access the order processing server 130 of the retailer via a consumer computing device 110, which may be a stationary, portable, and/or hand-held electronic device, for example, a desktop computer, a laptop computer, a tablet, a mobile phone, or any other electronic, processor-based device that may be configured for data entry and communication over the network 125 with the order processing server 130, as well as one or more of the customer information database 140, retailer computing device 150, inventory management database 160, and customer computing device 120. In some embodiments, the consumer may access the order processing server 130 of the retailer via a graphical interface 112 displayed to the consumer on the consumer computing device 110. The graphical interface 112 may include one or more graphical input fields 114 in the form of menu options and/or sub-interfaces that permit the consumer to place an order request for one or more products 190, to select pick up options for the one or more products 190 in the order request, and to communicate with the retailer computing device 150 and/or order processing server 130 after submitting the order request. In some embodiments, the graphical interface 112 may be a retailer-associated mobile application (app) installed on the consumer computing device 110 and configured to display various menu options, notifications, and/or alerts for the consumer. For example, electronic alerts may be transmitted to the consumer computing device 110 from the retailer computing device 150 and/or order processing server 130 and displayed to the consumer via the graphical interface 112 of the consumer computing device 110, requiring the consumer to respond to the alerts by selecting appropriate input fields 114 in the graphical interface 112.

In some embodiments, after submitting an order request for one or more products 190 via the order processing server 130 using the graphical interface 112 of the consumer computing device 110, the consumer does not select an option to have the products 190 in the order request delivered to a residence of the consumer, and does not select an option to personally pick up the products 190 from a store of the retailer associated with a geographic location of the consumer. Instead, the consumer selects, using appropriate input fields 114 of the graphical interface 112 of the consumer computing device 110, an option to have the products 190 in the order request to be picked up at a location other than a store of a retailer, and more specifically, an option to have the products 190 in the order request to be picked up at a product pick up location 180 provided by a customer of the retailer. A product pick up location 180 may include but is not limited to a residence of the customer of the retailer, a place of business of the customer of the retailer, or a storage area of the customer of the retailer.

In some embodiments, the order processing server 130 is configured for various functions relating to the processing of an order request by the consumer, including but not limited to: transmission to the retailer computing device 150, the consumer's election of pick-up of the ordered products 190 at a product pick up location 180; receipt and processing of an order request by a consumer for one or more products 190 from the consumer computing device 110; receipt and processing of funds from the consumer for the products 190 ordered by the consumer and for the additional cost of picking up the products 190 from the product pick up location 180 provided by the customer of the retailer; and transfer and/or credit of funds received from the consumer for the additional product pick up cost to a customer who provides the product pick up location 180.

The exemplary system of FIG. 1 includes a retailer computing device 150, which may be a stationary or portable electronic device, for example, a desktop computer, a laptop computer, a tablet, a mobile phone, or any other electronic device including a processor-based control circuit. In the embodiment of FIG. 1, the retailer computing device 150 is configured for data entry and processing, as well as for communication with other devices of system 100 via the network 125 which, as described above, may be a wide-area network (WAN), a local area network (LAN), a personal area network (PAN), a wireless local area network (WLAN), or any other wired or wireless internet or intranet network, or combinations of such networks.

The exemplary inventory management database 160 of FIG. 1 is configured to store electronic data associated with the products 190 stocked at product pick up locations 180 provided by customers of the retailer, as well as products 190 ordered by consumers and designated for pick up by the consumers from product pick up locations 180 provided by customers of the retailer. Exemplary electronic data that may be stored in the inventory management database 160 may include, but is not limited to: electronic data indicating an inventory of products 190 available at product pick up locations 180 and which may be ordered by consumers for pick up at product pick up locations 180; electronic data indicating an identity of a customer associated with a given product pick up location 180; electronic data relating to product order requests by the consumers; electronic data relating to product restocking orders by the product pick up locations 180. As shown in FIG. 1, the inventory management database 160 can communicate over the network 125 with one or more of the retailer computing device 150, customer information database 140, order processing server 130, customer computing device 120, and consumer computing device 110.

In some embodiments, the consumer may access, review, and/or update the electronic data in the customer information database 140 and/or the inventory management database 160 via the graphical interface 112 displayed to the consumer via the consumer computing device 110. The graphical interface 112 may include one or more graphical input fields 114 in the form of menu options and/or sub-interfaces that permit the consumer to: manage product orders (e.g., by adding one or more products 190 to an order request or removing one or more products 190 from the order request); pre-grant permission to one or more friends or family members of the consumer (whose identifying information (e.g., first and last name) may be provided by the consumer and stored in the customer information database 140 or obtained from one or more social media websites) to pick up products 190 ordered by the consumer from a product pick up location 180; update the consumer's account information, alert notifications, and product pick up options (e.g., acceptable geographic area for product pick up locations 180, preferred list of product pick up locations 180, etc.) for products 190 ordered by the consumer from the retailer via the order processing server 130; define a specific date and time window when the products 190 are to be picked up (by the consumer or consumer's friend or family member) from a product pick up location 180; and define one or more products 190 that are to be reordered from the retailer and picked up (by the consumer or a pre-defined friend or family member of the consumer) from a product pick up location 180 at regular time intervals.

It will be appreciated that the products 190 ordered by the consumer do not necessarily have to be picked up at the product pick up location 180 by the consumer or a friend or family member of the consumer. In one approach, the graphical interface 112 may include one or more graphical input fields 114 in the form of menu options and/or sub-interfaces that permit the consumer to specify that the products 190 identified in the consumer's order request are delivered by the customer (e.g., for a pre-agreed upon additional delivery fee) from the product pick up location 180 to a geographic location specified by the consumer.

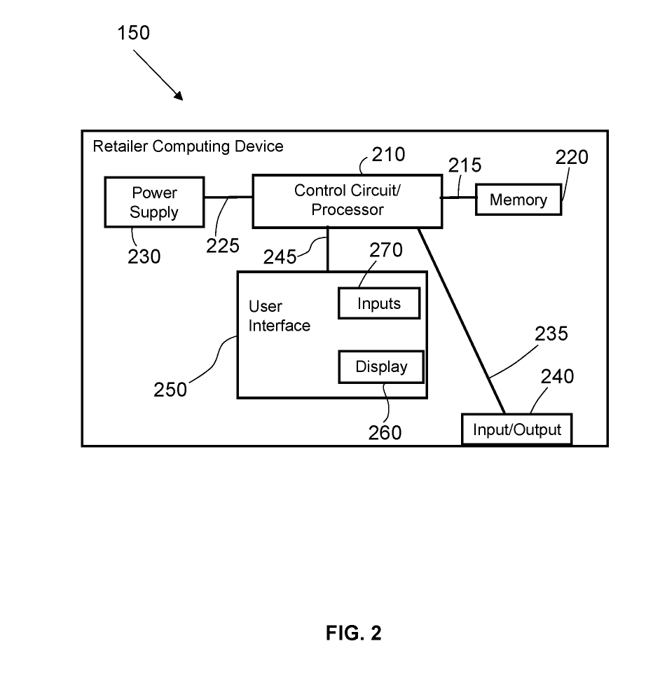

With reference to FIG. 2, an exemplary retailer computing device 150 configured for use with exemplary systems and methods described herein may include a control circuit 210 including a processor (for example, a microprocessor or a microcontroller) electrically coupled via a connection 215 to a memory 220 and via a connection 225 to a power supply 230. The control circuit 210 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

This control circuit 210 can be configured (for example, by using corresponding programming stored in the memory 220 as will be well understood by those skilled in the art) to carry out one or more of the steps, actions, and/or functions described herein. In some embodiments, the memory 220 may be integral to the processor-based control circuit 210 or can be physically discrete (in whole or in part) from the control circuit 210 and is configured to non-transitorily store the computer instructions that, when executed by the control circuit 210, cause the control circuit 210 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory and/or the control circuit may be referred to as a non-transitory medium or non-transitory computer readable medium. The control circuit 210 of the retailer computing device 150 is also electrically coupled via a connection 235 to an input/output 240 that can receive signals to and receive signals from the order processing server 130, customer information database 140, inventory management database 160, consumer computing device 110, customer computing device 120, or from any other computing device that can communicate with the retailer computing device 150 via a wired or wireless connection over the network 125.

In the embodiment shown in FIG. 2, the processor-based control circuit 210 of the retailer computing device 150 is electrically coupled via a connection 245 to a user interface 250, which may include a visual display or display screen 260 (e.g., LED screen) and/or button input 270 that provide the user interface 250 with the ability to permit an operator of the retailer computing device 150 to manually control the retailer computing device 150 by inputting commands via touch-screen and/or button operation and/or voice commands to, for example, to associate products 190 ordered by a consumer with a product pick up location 180 provided by the customer of the retailer where the consumer can pick up the products 190. It will be appreciated that the performance of such functions by the processor-based control circuit 210 of the retailer computing device 150 is not dependent on a human operator, and that the control circuit 210 may be programmed to perform such functions without a human operator.

In some embodiments, the display screen 260 of the retailer computing device 150 is configured to display various graphical interface-based menus, options, and/or alerts that may be transmitted to the retailer computing device 150 and displayed on the display screen 260 in connection with various aspects of an order request submitted by a consumer. The inputs 270 of the retailer computing device 150 may be configured to permit an operator to navigate through the on-screen menus on the retailer computing device 150 and make changes and/or updates to the product pick up location 180 where the consumer will be permitted to pick up the products 190 ordered by the consumer from the retailer. It will be appreciated that the display screen 260 may be configured as both a display screen and an input 270 (e.g., a touch-screen that permits an operator to press on the display screen 260 to enter text and/or execute commands.)

In one aspect, the control circuit 210 of the retailer computing device 150 is programmed to analyze the geographic location of a consumer who submitted an order request for one or more products 190 via the order processing server 130 and to determine a product pick up location 180 that is located at a physical address that is closest to (i.e., the shortest distance from) the geographic location of the consumer who submitted the order request. In other words, in some embodiments, after a consumer submits an order request for one or more products 190 via the order processing server 130, the retailer computing device 150 accesses (over the network 125) the customer information database 140, which stores the geographic addresses of each consumer and each product pick up locations 180 made available by customers of the retailer. Then, the control circuit 210 of the retailer computing device 150 selects, from product pick up locations 180 stored in the customer information database 140, a product pick up location 180 that is most closely associated with the physical address of the consumer who submitted the order request.

In some embodiments, the control circuit 210 of the retailer computing device 150 is programmed to generate customer alerts in connection with the order requests for one or more products 190 submitted by consumers via the order processing server 130. The customer alerts may be generated by the control circuit 210 of the retailer computing device 150 based on information received from the order processing server 130, customer information database 140, inventory management database 160, consumer computing device 110, and/or customer computing device 120. For example, customer alerts may be transmitted from the retailer computing device 150 via the network 125 to the consumer computing device 110 and customer computing device 120, and the consumer computing device 110 and customer computing device 120 may transmit data responsive to the alerts (or to other data) to the retailer computing device 150 via the network 125.

In some embodiments, the retailer computing device 150 transmits a signal over the network 125 to the consumer computing device 110 including an alert identifying a pick up location 180 provided by a customer of the retailer. In one approach, the retailer computing device 150 transmits a signal over the network 125 to the customer computing device 120 of a customer including an alert indicating that the product pick up location 180 provided by the customer was selected by the retailer computing device 150 as the pick up location for an order request submitted by a consumer from a consumer computing device 110 via the order processing server 130. The alerts sent to the consumer computing device 110 and customer computing device 120 may include but are not limited to short message service (SMS) messages, electronic mail (e-mail) messages, instant messenger messages, voice mail messages, and push notifications (to a mobile application installed on the consumer computing device 110 and/or customer computing device 120).

In some embodiments, the control unit of the retailer computing device 150 transmits a first electronic notification (i.e., an alert) including a query (e.g., via SMS, email, mobile app push notification, electronic mail, instant messenger, or the like) to a customer computing device 120 selected by the control circuit 210 of the retailer computing device 150, for example, because the product pick up location 180 was determined by the control circuit 210 to be located physically closest to the geographic location of the consumer who submitted an order request for one or more products 190. Such an electronic query may request that the customer indicate agreement to permit the consumer to pick up the products 190 at the product pick up location 180 within the time period specified by the consumer when submitting the order request, or within a time period specified by the customer providing the product pick up location 180. The customer can then use the customer computing device 120 to respond to this electronic notification or query by indicating, by entering information into the graphical interface 122 of the customer computing device 120, agreement or disagreement with permitting the consumer to pick up the product(s) at the product pick up location 180 operated by the customer.

If the customer indicates disagreement or unavailability of the product pick up location 180 initially selected by the control circuit 210 of the retailer computing device 150, the control circuit 210 is programmed to access the customer information database 140 to select an alternative product pick up location 180 where the consumer may pick up the products 180 requested to be ordered by the consumer. For example, in one approach, the control circuit 210 is programmed to analyze geographic locations of other product pick up locations 180 to determine a second, alternative product pick up location 180 located at a geographic location that is second closest (after the product pick up location 180 determined to be unavailable) to the geographic location of the consumer who submitted the order request via the order processing server 130.

In one aspect, the control circuit 210 of the retailer computing device 150 is configured to receive a signal from the customer computing device 120 that includes a response of the customer indicating availability of the product pick up location 180 to the consumer for picking up the products 190 listed in the consumer's order request. In response to receipt of such a signal from the customer computing device 120 over the network 125, the control circuit 210 of the retailer computing device 150 is programmed to transmit an electronic notification over the network 125 to the consumer computing device 110 to indicate to the consumer that the products 190 ordered by the consumer will be available for pick up at the product pick up location 180 made available by the customer. In some embodiments, the control circuit 210 of the retailer computing device 150 may be programmed to transmit, via the network 125, a first electronic notification to the consumer computing device 110 indicating an additional cost to the consumer of picking up the products 190 identified in the order request from the product pick up location 180 selected by the retailer computing device 150. It will be appreciated that the additional cost to the consumer for picking up the products 190 from the product pick up location 180 may be determined by the customer who provides this product pick up location 180 or by the retailer computing device 150.

In some embodiments, the control circuit 210 of the retailer computing device 150 is configured to determine the additional cost to the consumer of picking up the products 190 identified in the consumer's order request from a given product pick up location 180. In some embodiments, the control circuit 210 of the retailer computing device 150 is configured to generate and transmit an electronic notification to a customer computing device 120, with the electronic notification requesting that the customer quote, via the customer computing device 120, the additional cost to the consumer of picking up the products 190 listed in the consumer's order request from the product pick up location 180 provided by this customer. The control circuit 210 of the retailer computing device 150 is also configured to receive, from the customer computing device 120, a signal over the network 125 including a quote of the extra cost to the consumer of picking up the products 190 from this product pick up location 180.

In some embodiments, the control circuit 210 of the retailer computing device 150 may be programmed to send an electronic notification or alert including a query (e.g., via SMS, email, mobile app push notification, electronic mail, instant messenger, or the like) to the consumer computing device 110. Such an electronic query may accompany an electronic customer alert indicating the amount of the additional cost to the consumer for picking up the products 190 listed in the consumer's order request, and asking the consumer to respond, via the graphical interface 112 and/or input fields 114 of the consumer computing device 110, by indicating whether the consumer agrees to pay this additional fee for the convenience of picking up the products 190 at the product pick up location 180 selected by the retailer computing device 150. In some embodiments, the consumer is permitted to use the graphical interface 112 of the consumer computing device 110 to respond to this query by indicating (e.g., by checking one or more appropriate input fields 114 of the graphical interface 112) that the consumer agrees to pay the additional fee for picking up the products 190 at the product pick up location 180.

In one aspect, in response to the consumer indicating, via the graphical interface 112, agreement to pay for the additional cost to pick up the products 190 from the product pick up location 180 selected by the retailer computing device 150, the consumer may be presented with a prompt in the graphical interface 112 to proceed to authorize payment for both the products 190 listed in the order request and the additional product pick up cost the consumer agreed to pay. In one approach, the payment by the consumer for the products 190 and for the additional pick up cost may be effectuated via the order processing server 130 withdrawing funds over the network 125 from the consumer's credit card on file in the customer information database 140, and then crediting (i.e., transferring) a portion of or the entire amount of the consumer-paid pick up fee to a credit card or bank account associated in the customer information database 140 with the customer who is associated in the customer information database 140 with the product pick up location 180 where the consumer will be picking up the products 190.

In some embodiments, the order processing server 130 is configured to credit the customer's account with the proceeds of the product pick up fee after the funds corresponding to the product pick up fee are withdrawn from the consumer's account and before the consumer picks up the products 190 from the product pick up location 180 provided by the customer. In some embodiments, the order processing server 130 is configured to credit the customer's account with the proceeds of the product pick up fee after the funds corresponding to the product pick up fee are withdrawn from the consumer's account only after a confirmation is received (e.g., by the order processing server 130 or retailer computing device 150) that the products 190 were successfully picked up by the consumer from the product pick up location 180.

In some embodiments, in response to receiving an indication that the consumer has paid for the additional cost of picking up the products 190 from a first pick up location 180, the control circuit 210 of the retailer computing device 150 is programmed to transmit a notification to the customer computing device 120 to notify the customer that the consumer has paid for the additional cost to pick up the products 190 from the product pick up location 180, and that the account of the customer has been credited (or will be credited after a successful pick up) accordingly. In one approach, the control circuit 210 of the retailer computing device 150 is programmed to transmit an electronic notification to the consumer computing device 110 to indicate to the consumer an address of the product pick up location 180, and to transmit a signal to the customer computing device 120 including a notification indicating a time period of when the consumer will pick up the purchased products 190 from the product pick up location 180.

In some embodiments, prior to the consumer arriving at the product pick up location 180 to pick up the products ordered by the consumer, the control circuit 210 of the retailer computing device 150 is programmed to transmit one electronic notification to the consumer computing device 110 including authentication credentials that would enable the consumer to verify an identify of the customer of the retailer who is providing the product pick up location 180 upon arriving at the first pick up location, and to transmit a separate electronic notification to the customer computing device 120 including authentication credentials of the consumer to enable the customer who is providing the product pick up location 180 to verify identity of the consumer when the consumer arrives at the pick up location 180 for picking up the products 190. Such authentication credentials may include but are not limited to: name of the consumer and/or customer, address of the consumer and/or customer, phone number of the consumer and/or customer, a unique, randomly-generated code, or the like. The provision of authentication credentials of the person who is going to be picking up the products 190 to the person operating the product pick up location 180 and vice versa advantageously decreases and/or eliminates the possibility that a person other than the consumer picks up the consumer's products 190 from the product pick up location 180 provided by the customer of the retailer.

In some embodiments, the control circuit 210 of the retailer computing device 150 is configured to receive an electronic confirmation from one or both of the consumer computing device 110 and customer computing device 120 indicating that the products 190 purchased by the consumer from the retailer have been successfully picked up by the consumer from the product pick up location 180 provided by the first customer of the retailer. In one approach, the control circuit 210 of the retailer computing device 150 is configured to receive an electronic confirmation from the consumer computing device 110 indicating that the consumer has successfully picked up the products 190 purchased by the consumer from the product pick up location 180 provided by the customer of the retailer. Such an electronic confirmation may be generated, for example, via the consumer entering appropriate pick up confirmation information via the input fields 114 of the graphical interface 112 of the consumer computing device 110.

In another approach, the control circuit 210 of the retailer computing device 150 is configured to receive an electronic confirmation from the customer computing device 120 indicating that the consumer has successfully picked up the products 190 purchased by the consumer from the product pick up location 180 provided by the customer of the retailer. Such an electronic confirmation may be generated, for example, via the customer entering appropriate pick up confirmation information via the input fields 124 of the graphical interface 122 of the customer computing device 120. After such electronic confirmations of successful product pick up by the consumer at the product pick up location 180 are received at the retailer computing device 150, such electronic confirmations may be transmitted from the retailer computing device 150 to the customer information database 140 and associated with the respective accounts of the consumer and the customer.

In some embodiments, the control circuit 210 of the retailer computing device 150 is configured to receive electronic information indicating a rating of the consumer from the consumer computing device 110 after the consumer successfully picked up the products 190 purchased by the consumer from the product pick up location 180 provided by the customer of the retailer. Such electronic rating information may be generated, for example, via the consumer entering appropriate rating information via the input fields 114 of the graphical interface 112 of the consumer computing device 110. In some embodiments, the control circuit 210 of the retailer computing device 150 is configured to receive electronic information indicating a rating of the consumer from the customer computing device 120 after the consumer successfully picked up the products 190 purchased by the consumer from the product pick up location 180 provided by the customer of the retailer. Such an electronic rating information may be generated, for example, via the consumer entering appropriate rating information via the input fields 124 of the graphical interface 122 of the consumer computing device 110. The ratings received from the consumer computing device 110 and the customer computing device 120 enable the control circuit 210 to select product pick up locations 180 having higher ratings when determining which product pick up location 180 to select for the same or different consumer in response to a future order request by this consumer or by other consumers in the same geographic area.

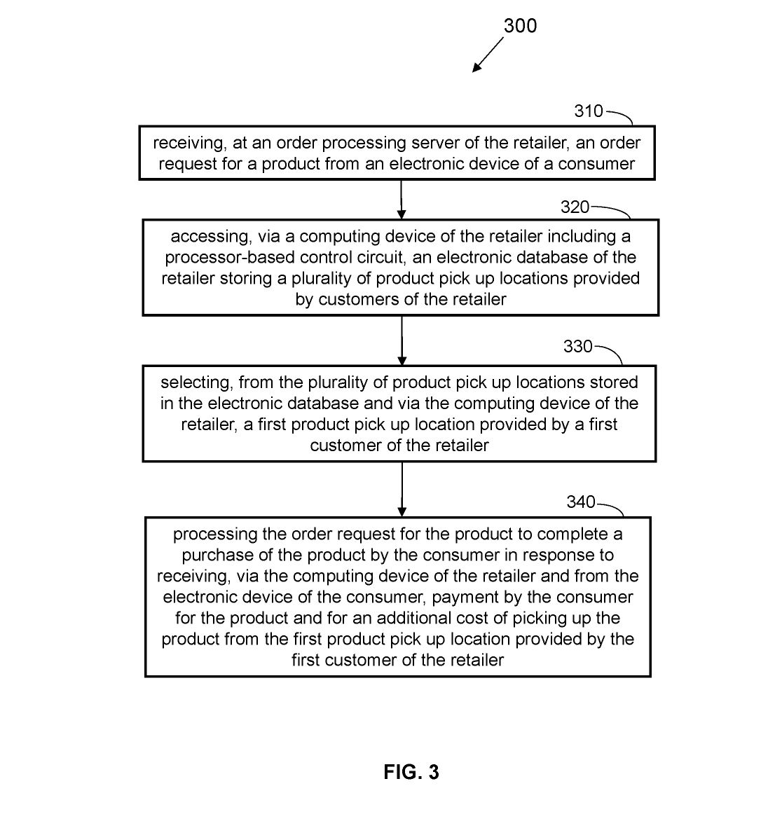

FIG. 3 shows an embodiment of an exemplary method 300 of facilitating pick up of products 190 purchased by consumers from a retailer at a pick up location provided by a customer of the retailer. After a consumer submits an order request for one or more products 190 to the retailer via an order processing server 130 of the retailer, the method 300 of FIG. 3 includes receiving, at an order processing server 130 of the retailer, an order request for one or more products 190 from an electronic device of a consumer (i.e., consumer computing device 110) (step 310). In the method 300 of FIG. 3, when submitting an order request to the order processing server 130 over the network 125 via the consumer computing device 110, the consumer does not elect to have the ordered products 190 delivered by the retailer to the consumer, or to personally pick up the ordered products 190 from a store operated by the retailer, but instead elects (e.g., via selecting appropriate input fields 114 in the graphical interface 112 of the consumer computing device 110) to have the products 190 ordered by the consumer picked up from a product pick up location 180 provided by a customer of the retailer and associated with the geographic location of the consumer.

After the order request of the consumer for one or more products 190 is processed at the order processing server 130, the exemplary method 300 further includes accessing, via a computing device of the retailer (i.e., retailer computing device 150) including a processor-based control circuit 210, an electronic database of the retailer (i.e., customer information database 140) storing a plurality of product pick up locations 180 provided by customers of the retailer (step 320). In one aspect, after a consumer elects pick up of the products 190 wished to be ordered by the consumer from a pick up location 180, the retailer computing device 150 accesses the customer information database 140 to retrieve a list of product pick up locations 180 provided by customers of the retailer that are associated with a geographic location of the order-placing consumer.

After the retailer computing device 150 accesses a list of product pick up locations 180 from which the consumer may pick up the products 190 identified in the order request of the consumer, the method 300 of FIG. 3 includes selecting, from the plurality of product pick up locations 180 stored in the customer information database 140 and via the retailer computing device 150, a first product pick up location 180 provided by a first customer of the retailer (step 330). In some embodiments, the selection of the first product pick up location 180 by the retailer computing device 150 includes analyzing, via the retailer computing device 150, geographic proximity of the product pick up locations 180 relative to the geographic location of the consumer to determine a product pick up location 180 that is located geographically closest to the consumer. In one aspect, this analysis is performed by retrieving, via the retailer computing device 150, the address of the consumer and the addresses of the product pick up locations 180 associated with the consumer's geographic location, and by using map-based analytics to measure a distance from the address of the consumer to the address of each of the product pick up locations 180. In some embodiments, the product pick up locations 180 may be ranked in order of being closest to furthest to the address of the consumer, which is stored in the customer information database 140.

It is to be appreciated that the retailer computing device 150 is not limited to selecting a pick up location 180 that is geographically closest to the address associated with the consumer, but may select a pick up location 180 that may be more convenient to the consumer, for example, due to being located on a direct path of the consumer from work to home or from home to work. In some embodiments, the consumer may preselect a preferential order of product pick up locations 180 for the retailer computing device 150 to select from when selecting a product pick up location 180 for a given product order request submitted by the consumer.

After the retailer computing device 150 selects a product pick up location 180 where the consumer is to pick up the products 190 requested to be ordered by the consumer from the retailer, the product pick up location 180 selected by the retailer computing device 150 is associated in the customer information database 140 and/or the inventory management database 160 with the order request submitted by the consumer. In some embodiments, as described above, after the product pick up location 180 is selected by the retailer computing device 150, the retailer computing device 150 transmits over the network 125 an electronic notification to a customer computing device 120 requesting the customer to confirm that the consumer will be permitted to pick up the products 190 at the product pick up location 180 provided by the customer within a time frame requested by the consumer when placing the order request.

In one aspect, the method 300 may include transmitting a notification from the retailer computing device 150 to the customer computing device 120 a notification requesting that the customer of the retailer generate a quote representing the additional cost to the consumer of picking up the ordered products 190 from the product pick up location 180, and then receiving at the retailer computing device 150 a transmission including such a quote over the network 125 from the customer computing device 120. After the customer receives such an electronic notification from the retailer computing device 150 over the network 125 and uses the graphical interface 122 of the customer computing device 120 to indicate agreement to permit the consumer to pick up the products 190 at the product pick up location 180, the method 300 may further include transmitting an indication of additional cost to the consumer for picking up the products 190 at the product location 180 from the customer computing device 120 via the network 125 to the retailer computing device 150. This indication of additional cost may be entered by the customer using the input fields 124 of the graphical interface 122 of the customer computing device 120. Then, in some embodiments, the method 300 of FIG. 3 further includes transmitting an electronic notification from the retailer computing device 150 over the network 125 to the consumer computing device 110, the notification indicating the additional cost to the consumer of picking up the products 190 wished to be ordered by the consumer at the product pick up location 180.

If the consumer agrees to pay for the additional cost of pick up of the products 190 from the product pick up location 180 provided by the customer of the retailer, in some embodiments, the method 300 may further include receiving, at the retailer computing device 150, a signal over the network 125 from the consumer computing device 110 indicating such agreement of the customer. Then, the method 300 may include receiving, via the order processing server 130 of the retailer, funds from the consumer to cover the cost of the products 190 and the additional cost of picking up the products 190 at the selected product pick up location 180. As described above, such funds may be withdrawn via the order processing server 130 from a credit card or bank account of the consumer that is stored on file in the customer information database 140. The method 300 may then include transferring to the customer, via the order processing server 130, at least a portion of the funds received by the retailer via the order processing server 130 from the consumer to cover the additional cost of picking up the products 190 at the product pick up location 180 provided by the customer. As described above, such funds may be credited to the customer's account via the order processing server 130 to a credit card or bank account of the customer that is stored on file in the customer information database 140.

The exemplary method 300 of FIG. 1 further includes processing the consumer's order request for the products 190 to complete a purchase of the products 190 by the consumer in response to receiving, via the retailer computing device 150, payment by the consumer for the product 190 and for an additional cost of picking up the products 190 from the product pick up location 180 provided by the customer of the retailer. After the funds received from the consumer are transferred to the customer, in some embodiments, the method 300 may further include transmitting one electronic notification from the retailer computing device 150 to the consumer computing device 110 to indicate to the consumer an address of the selected pick up location 180. In one approach, the method 300 may include including, in such an electronic notification, authentication credentials of the customer of the retailer at the pick up location 180 to enable the consumer to verify the identity of the customer of the retailer upon arriving at the pick up location 180. It will be appreciated that the authentication credentials do not have to be transmitted from the retailer computing device 150 to the consumer computing device 110 in the electronic transmission that includes the address of the product pick up location 180, but may be sent to the consumer computing device 110 from the retailer computing device 150 in a later transmission.

In some embodiments, after the funds received from the consumer are transferred to the customer, in some embodiments, the method 300 includes transmitting another electronic notification from the retailer computing device 150 to the customer computing device 120 to provide the customer with a time period (e.g., a specific date and a specific start time and end time) of when to expect the consumer to pick up the purchased products 190 from the pick up location 180. In one approach, the method 300 may include including, in such an electronic notification, authentication credentials (e.g., name, verification code, etc.) of the consumer to enable the customer at the product pick up location 180 to verify identity of the consumer when the consumer arrives at the product pick up location 180 to pick up the products 190 ordered by the consumer.

After the products 190 are picked up by the consumer from the product pick up location 180 provided by the customer, in some embodiments, the method 300 may further include receiving, at the retailer computing device 150, an electronic confirmation from each of the consumer computing device 110 and the customer computing device 120 indicating that the products 190 purchased by the consumer from the retailer have been successfully picked up by the consumer from the product pick up location 180 provided by the customer of the retailer. As described above, this allows the retailer to confirm that the products 190 were successfully picked up by the consumer from the product pick up location 180 provided by the customer of the retailer. In some embodiments, the order processing server 130 transfers a portion of the funds received from the consumer to cover the additional cost of picking up the products at the product pick up location 180 only after an electronic confirmation of electronic pick up is received from each of the consumer computing device 110 and the customer computing device 120.

In some embodiments, after the products 190 are picked up by the consumer from the product pick up location 180 provided by the customer, the method 300 may further include receiving, at the retailer computing device 150, an electronic rating of the consumer from the customer computing device 120 and an electronic rating of the product pick up location 180 from the consumer computing device 110. The ratings received from the consumer computing device 110 and the customer computing device 120 enable the control circuit 210 to select product pick up locations 180 having higher ratings when determining which product pick up location 180 to select for the same or different consumer in response to a future order request.

The systems and methods described herein advantageously allow customers to purchase products from a retailer and to pick up such products from conveniently located product pick up location provided by another customer of the retailer. Thus, some customers of the retailer are provided with an ability to pick up the products from a location that is more convenient for them than the retailer's brick-and-mortar store, and some customers of the retailer are provided with an opportunity to make some extra income by offering their home, business, or other storage location as an authorized product pick up location for consumers who purchase from the retailer. Such systems and methods provide a significant time savings, convenience, and/or income potential for customers of the retailer and are likely to increase customer loyalty to the retailer.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system of facilitating consumer pick up of products purchased from a retailer, the system comprising:
an order processing server of the retailer configured to receive an order request for a product from an electronic device of a consumer;
a computing device of the retailer in communication with the order processing server and including a processor-based control circuit, the computing device of the retailer being configured to access an electronic database of the retailer storing a plurality of product pick up locations provided by customers of the retailer;
wherein the control circuit of the computing device of the retailer is configured to select, from the plurality of product pick up locations stored in the electronic database, a first product pick up location provided by a first customer of the retailer; and
wherein the order processing server is configured to process the order request for the product to complete a purchase of the product by the consumer in response to receiving, from the electronic device of the consumer, payment by the consumer for the product and for an additional cost of picking up the product from the first product pick up location provided by the first customer of the retailer.

2. The system of claim 1, wherein the order processing server is configured to enable the consumer to elect to pick up the product at a location other than a retail facility of the retailer prior to making the payment for the product.

3. The system of claim 1, wherein the control circuit of the computing device of the retailer is configured to transmit a first electronic notification to the electronic device of the consumer, the first electronic notification indicating an additional cost to the consumer of picking up the product from the first product pick up location.

4. The system of claim 3, wherein the control circuit of the computing device of the retailer is configured to transmit a second electronic notification to an electronic device of the first customer of the retailer, the second electronic notification requesting the first customer of the retailer to quote the additional cost to the consumer of picking up the product from the first product pick up location, and to receive, from the electronic device of the first customer, a quote of the additional cost to the consumer of picking up the product from the first product pick up location.

5. The system of claim 3, wherein the control circuit of the computing device of the retailer is configured to determine the additional cost to the consumer of picking up the product from the first product pick up location.

6. The system of claim 1, wherein the control circuit of the computing device of the retailer is configured to select the first product pick up location based on the first pick up location being located at a closest distance to a geographic location of the consumer as compared to any other of the product pick up locations provided by the customers of the retailer stored in the electronic database.

7. The system of claim 1, wherein the control circuit of the computing device of the retailer is configured to transmit a first electronic notification to the electronic device of the consumer to indicate to the consumer an address of the selected first pick up location, and to transmit a second electronic notification to an electronic device of the first customer of the retailer to indicate to the first customer of the retailer a time period of when to expect the consumer to pick up the purchased product from the first pick up location.

8. The system of claim 7, wherein the first electronic notification includes authentication credentials of the first customer of the retailer at the first pick up location to enable the consumer to verify an identify of the first customer of the retailer upon arriving at the first pick up location, and wherein the second electronic notification includes authentication credentials of the consumer to enable the first customer at the first pick up location to verify identity of the consumer when the consumer arrives at the first pick up location for picking up the product.

9. The system of claim 1, wherein the order processing server is configured to transfer, to the first customer of the retailer, at least a portion of funds received from the consumer for the additional cost of picking up the product from the first product pick up location provided by the first customer of the retailer.

10. The system of claim 1, wherein the control circuit of the computing device of the retailer is configured to receive a confirmation from each of the electronic device of the consumer and from an electronic device of the first customer of the retailer at the first pick up location that the product purchased by the consumer from the retailer has been successfully picked up by the consumer from the first pick up location provided by the first customer of the retailer.

11. A method of facilitating consumer pick up of products purchased from a retailer, the method comprising:
receiving, at an order processing server of the retailer, an order request for a product from an electronic device of a consumer;
accessing, via a computing device of the retailer including a processor-based control circuit, an electronic database of the retailer storing a plurality of product pick up locations provided by customers of the retailer;
selecting, from the plurality of product pick up locations stored in the electronic database and via the computing device of the retailer, a first product pick up location provided by a first customer of the retailer; and
processing the order request for the product to complete a purchase of the product by the consumer in response to receiving, via the computing device of the retailer and from the electronic device of the consumer, payment by the consumer for the product and for an additional cost of picking up the product from the first product pick up location provided by the first customer of the retailer.

12. The method of claim 11, wherein the receiving step further comprises enabling the consumer to elect to pick up the product at a location other than a retail facility of the retailer prior to making the payment for the product.

13. The method of claim 11, wherein the selecting step further comprises transmitting a first electronic notification from the computing device of the retailer to the electronic device of the consumer, the first electronic notification indicating an additional cost to the consumer of picking up the product from the first product pick up location.

14. The method of claim 13, wherein the transmitting step further comprises transmitting a second electronic notification from the computing device of the retailer to an electronic device of the first customer of the retailer, the second electronic notification requesting the first customer of the retailer to quote the additional cost to the consumer of picking up the product from the first product pick up location, and receiving, at the computing device of the retailer from the electronic device of the first customer, a quote of the additional cost to the consumer of picking up the product from the first product pick up location.

15. The method of claim 13, wherein the transmitting step further comprises determining, at the computing device of the retailer, the additional cost to the consumer of picking up the product from the first product pick up location.

16. The method of claim 11, wherein the selecting step further comprises selecting the first product pick up location based on the first pick up location being located at a closest distance to a geographic location of the consumer as compared to any other of the product pick up locations provided by the customers of the retailer stored in the electronic database.

17. The method of claim 11, wherein the processing step further comprises transmitting a first electronic notification from the computing device of the retailer to the electronic device of the consumer to indicate to the consumer an address of the selected first pick up location and transmitting a second electronic notification from the computing device of the retailer to an electronic device of the first customer of the retailer to indicate to the first customer of the retailer a time period of when to expect the consumer to pick up the purchased product from the first pick up location.

18. The method of claim 17, wherein the first electronic notification includes authentication credentials of the first customer of the retailer at the first pick up location to enable the consumer to verify an identify of the first customer of the retailer upon arriving at the first pick up location, and wherein the second electronic notification includes authentication credentials of the consumer to enable the first customer at the first pick up location to verify identity of the consumer when the consumer arrives at the first pick up location for picking up the product.

19. The method of claim 11, wherein the processing step further comprises transferring, to the first customer of the retailer and via the order processing server of the retailer, at least a portion of funds received from the consumer for the additional cost of picking up the product from the first product pick up location provided by the first customer of the retailer.

20. The method of claim 11, wherein the processing step further comprises receiving, at the computing device of the retailer, a confirmation from each of the electronic device of the consumer and from an electronic device of the first customer of the retailer at the first pick up location that the product purchased by the consumer from the retailer has been successfully picked up by the consumer from the first pick up location provided by the first customer of the retailer.
